(19) United States
(12) Patent Application Publication
(10) Pub. No.: US 2009/0037335 A1
(43) Pub. Date: Feb. 5, 2009

(54) Operator-assisted transaction system

(75) Inventor: Michael R. McNamara, Edinburgh (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/888,685

(22) Filed: Aug. 2, 2007

(51) Int. Cl. G06Q 40/00; H04L 9/00

(52) U.S. Cl. 705/54; 705/39

(57) ABSTRACT

An operator-assisted transaction system for communicating with a portable terminal presented by a customer. The system has a wireless transceiver for communicating with the portable terminal. The system also has a transaction processor coupled to the wireless transceiver. The transaction processor establishes communications with the portable terminal, receives a pre-staged request block including a pre-staged transaction from the portable terminal, and parses the request block to ascertain a customer identification and transaction details. The system also has an operator display coupled to the transaction processor for presenting the customer identification and transaction details to an operator to allow the operator to fulfill the pre-staged transaction.

### BACKGROUND

The present invention relates to an operator-assisted transaction system for communicating with a portable terminal.

One type of transaction system is implemented in a bank branch and includes a plurality of customer terminals at which customers can enter transaction details (customer identification, transaction type, transaction amount, and the like), and a smaller number of operator terminals that allow an operator to review and fulfill the entered transaction, for example, by dispensing a requested amount of cash to the customer. This type of transaction system, referred to herein as a “branch assist system”, has the advantage that an operator can serve a higher number of customers than in a traditional bank branch because the customer enters some of the transaction details himself or herself, thereby leaving the operator free to execute transactions.

According to a first aspect of the invention there is provided an operator-assisted transaction system for communicating with a portable terminal presented by a customer, the system comprising: a wireless transceiver; a transaction processor coupled to the wireless transceiver for (i) establishing communications with the portable terminal, (ii) receiving a pre-staged request block including a pre-staged transaction from the portable terminal, and (iii) parsing the request block to ascertain a customer identification and transaction details; and an operator display coupled to the transaction processor for presenting the customer identification and transaction details to an operator to allow the operator to fulfill the pre-staged transaction.

The request block may comprise a plurality of individual transactions, such as transfer of money from one account to another account, a bill pay transaction, a cash withdrawal transaction, and the like.

The request block may also include product request information, such as a request for information about a loan, an overdraft, a mortgage, or the like.

The transaction processor may be coupled to a plurality of transaction fulfillment channels, such as an automated transaction system for transferring funds between accounts; an operator terminal for fulfilling transactions that meet parameters established by an entity owning the operator-assisted transaction system; a supervisor terminal for approving transactions that do not meet transaction parameters; and a product specialist terminal.

The wireless transceiver may automatically route parsed transaction details to different channels, depending on the transaction requested. For example, if a large amount of cash is requested in a cash withdrawal transaction, then this may be routed to a supervisory operator; if product request information is included (such as information about a mortgage), then this may be routed to product specialist, who may schedule or conduct a private meeting with the customer. As another example, if a funds transfer request is included, this may be routed to an automated transaction system for execution, without requiring authorization by an operator.

The wireless transceiver may also provide an operator terminal with details of any transactions routed to other channels.

Preferably, the portable terminal includes a transaction interface that enables the customer to enter an identifier, such as a password, a PIN, a biometrics identifier, or such like, prior to entering a transaction. The transaction interface may validate the identifier, or it may assume that the identifier is correct and leave validation of the identifier to the operator-assisted transaction system.

By virtue of this aspect of the invention, a customer is able to prepare a transaction or a series of transactions remotely from an operator-assisted transaction system and then execute the transaction or series of transactions on arrival at the operator-assisted transaction system. This has the advantage that the transaction can be prepared in privacy, thereby avoiding fraud due to a third party observing the customer's identifier (such as the customer's PIN). This also has the advantage that the time taken to conduct the transaction at the operator-assisted transaction system is minimized because the transaction has already been entered.

Also by virtue of this aspect of the present invention, some of the customer terminals in a branch assist system (which are typically relatively expensive) can be replaced (or augmented) with relatively inexpensive transceivers, without any loss of functionality or customer throughput.

Preferably, the wireless transceiver implements near field communications. Alternatively, any other convenient wireless communication technology may be used, such as 802-11, IrDA, RFID, or the like. In some embodiments, the wireless transceiver may be a transponder.

Preferably, the transaction interface has a user interface element adapted to the requirements of the customer. For example, the user interface element may provide an audio interface for use by a visually impaired customer; alternatively and/or additionally, the user interface element may provide large font size text on a display. One advantage of having a personalized user interface is that the customer is always presented with the same user interface.

Preferably, the transaction interface has an encryption/decryption facility for storing the customer's PIN to ensure that a third party cannot access the customer's PIN by examining the storage area of the portable terminal.

Preferably, the operator-assisted transaction system uses an encryption/decryption facility to encrypt any messages transmitted to prevent fraud by third parties.

The portable terminal may be a personal digital assistant (PDA), a cellular radio-frequency telephone, or the like.

The portable terminal may be operable to assign a lifetime to each transaction so that if a transaction is not executed within that time period then the terminal invalidates the transaction. The terminal may allow the customer to select the length of the lifetime. The terminal may be operable to assign a delay to an entered transaction so that a transaction will not be valid until the delay has expired. The delay may be in the form of a date or time prior to which the transaction is not active.

The advantage of having a lifetime associated with each transaction is that if the terminal is lost or stolen then the transaction will be invalidated when the selected lifetime expires.

The terminal may assign a unique identification to each transaction and transmit this unique identification with the transaction.

The transaction interface may be configured having a transactions pending store and a transactions executed store, whereby all unexecuted transactions are located in the transactions pending store and are automatically moved to the transactions executed store after execution. The transaction interface may remove the identifier (e.g. the PIN) prior to moving the transaction to the executed store. The advantage of having a transactions executed store is that the customer has a history of previous transactions.

The portable terminal may be operable to provide different levels of access rights to a customer. For example, the portable terminal may allow access to all of the functions of the terminal, or only to the transaction interface, or only to the execute transaction function provided by the transaction interface. This may be used so that the owner of the portable terminal may restrict access to other functions performed by the portable terminal and allow a third party access rights extending only to the ability to execute an entered transaction.

According to a second aspect of the invention there is provided a method of executing a pre-staged transaction received from a portable terminal presented by a customer, the method comprising: establishing communications with the portable terminal; receiving a pre-staged transaction from the portable terminal; parsing the transaction to ascertain a customer identification and transaction details; and presenting the customer identification and transaction details to an operator to allow the operator to fulfill the pre-staged transaction.

### BRIEF DESCRIPTION OF THE DRAWINGS

These and other aspects of the invention will be apparent from the following specific description, given by way of example, with reference to the accompanying drawings, in which:

FIG. 1 is a schematic diagram of a bank branch including an operator-assisted transaction system according to one embodiment of the present invention;

FIG. 2 is a simplified block diagram of a portable terminal for use with the system of FIG. 1;

FIG. 3 is a pictorial view of the portable terminal of FIG. 2; and

FIGS. 4a to 4d are diagrams of a part (the display) of the portable terminal of FIG. 2, showing screen configurations at different stages of entering a transaction.

### DETAILED DESCRIPTION

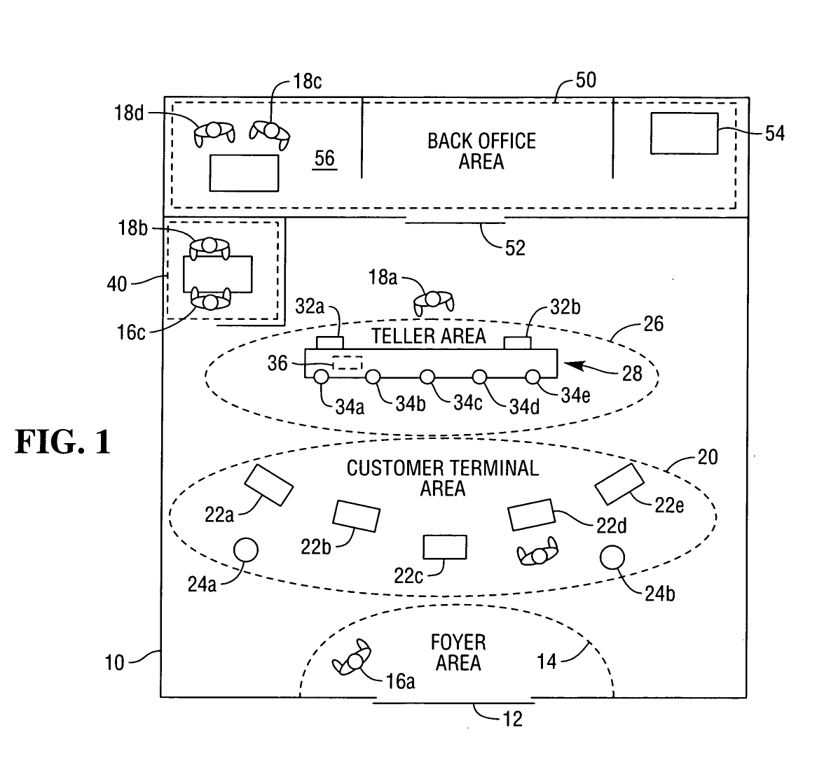

Referring to FIG. 1, there is shown a schematic plan view of a bank branch 10 housing an operator-assisted transaction system according to one embodiment of the present invention.

The bank branch 10 has an entrance door 12 leading to a foyer area (shown by dotted line 14) through which customers 16 (labeled 16a to 16c) pass when they wish to conduct a transaction or speak with bank staff 18 (labeled 18a to 18d). As a customer 16 passes through the foyer area 14 he/she reaches a customer terminal area (shown by dotted line 20) in which five customer-operated terminals 22a to 22e and two wireless transceiver stations 24a,b are located.

The bank branch 10 also includes a teller area (shown by dotted line 26) having a teller station 28. The teller station 28 is operated by a teller 18a (who is a member of the bank staff) and includes a display 30 (an operator display), two cash dispense units 32a,b operated by the teller 18a, a plurality of wireless transceivers 34 for use by customers 16, and a transaction processor 36. Transaction requests entered by customers 16 at the customer terminals 22 or transceivers 24 are presented to the teller 18a on the display 30, as will be described in more detail herein.

The bank branch 10 has a private meeting area (shown by dotted line 40) in which a product specialist 18b (who is a member of the bank staff acquainted with banking products) can meet with a customer 16c who wishes to discuss a banking product (such as a mortgage, a loan, or the like).

The bank branch 10 also has a back office (shown by dotted line 50) separated from the teller area 26 by a secure door 52. The back office 50 houses an authorization host 54 for authorizing transactions entered by the customers 16 at the customer-operated terminals 22 or transceivers 24. The back office 50 also has an administration area 56 where members of staff 18c,d work on non-customer-facing activities.

When a transaction entered by a customer at a customer-operated terminal 22 is authorized, the teller 18a calls that customer forward and executes the transaction. For example, if a cash dispense transaction has been entered by the customer 16, then the teller 18a instructs one of the cash dispense units 32 to dispense the requested amount of cash.

As will be appreciated by those of skill in the art, the authorization host 54, the teller station 28, the customer-operated terminals 22, and the wireless transceivers 24 and 34 are all interconnected by a secure network.

The transaction processor 36 controls the wireless transceivers 24,34, the cash dispense units 32, and the display 30. The transaction processor 36 can route transaction requests and product requests from the customer-operated terminals 22 and wireless transceivers 24,34 to the display 30, the authorization host 54, and computers in the back office area 50. The transaction processor 36 includes a conventional encryption/decryption facility to ensure that all transactions routed within the bank branch 10 are encrypted.

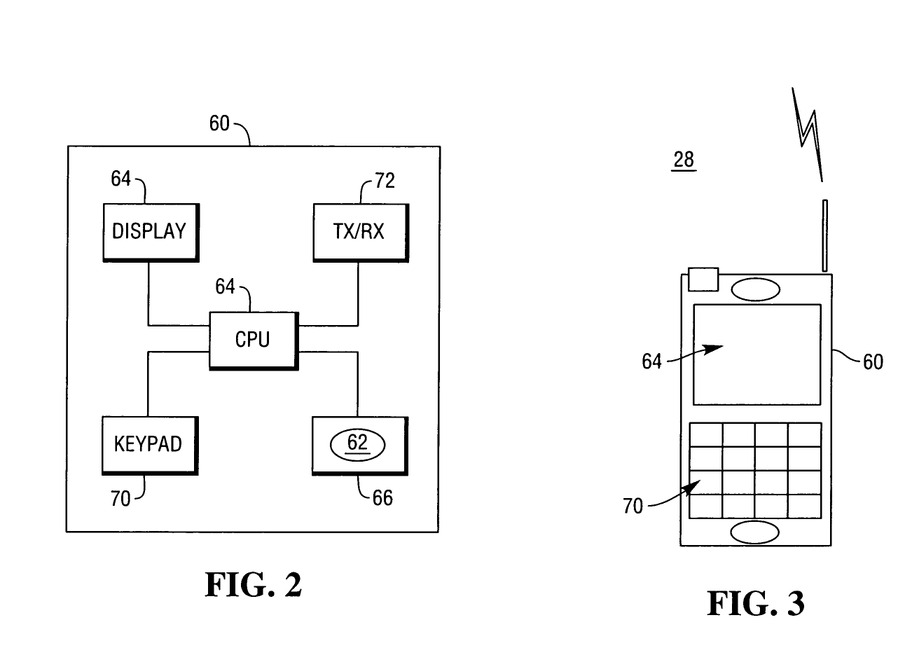

The wireless transceivers 24,34 interact with portable terminals carried by customers 16, as will be described with reference to FIG. 2, which is a simplified block diagram of a portable terminal 60 for use with the system of FIG. 1.

In this embodiment the portable terminal 60 is a conventional cellular telephone (cell phone) on which transaction software 62 is loaded.

In addition to specific components dedicated to telephony (microphone, loudspeaker, codec, and the like), which are not illustrated in FIG. 2, the cell phone 60 comprises a controller 64 and associated memory 66, a display 68, a keypad 70, and a wireless transceiver 72 in the form of a near field communication (NFC) device.

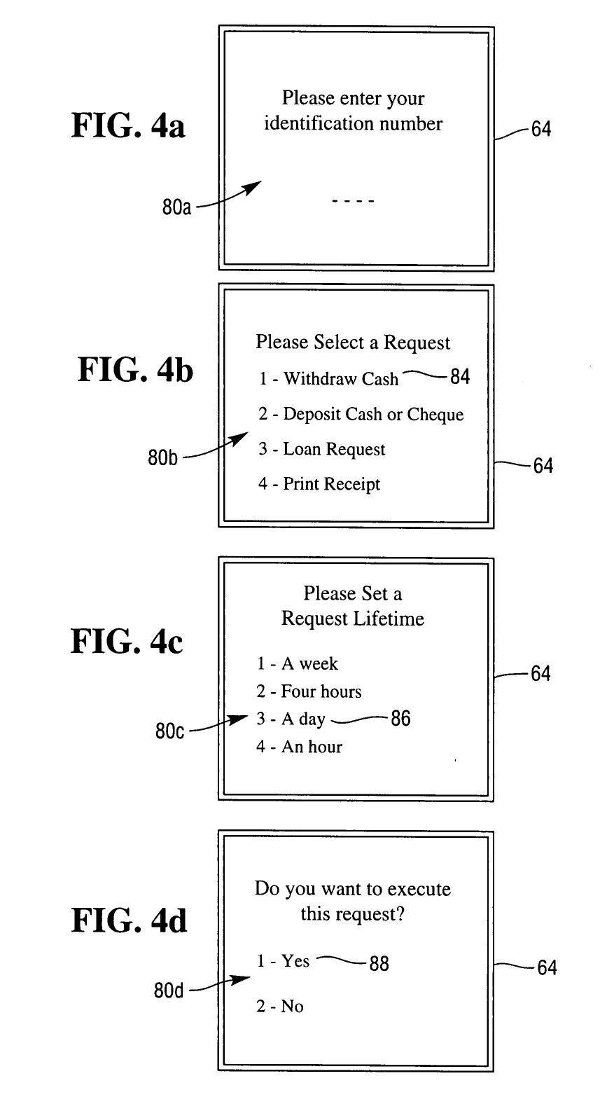

The transaction software 62 provides a graphical transaction interface 80 (best seen in FIGS. 4a to 4d) and an encryption/decryption facility.

A customer 16 can use his/her cell phone 60 to enter (also referred to as “pre-stage”) a request block while remote from the bank branch 10, as will now be described with reference to FIGS. 4a to 4d. The request block typically comprises a transaction or sequence of transactions but may include or comprise a product request or a meeting with bank staff. Once a request block has been entered, the customer 16 can then convey the cell phone 60 to the bank branch 10 and execute the pre-staged request block.

To enter a transaction, the customer 16 uses the keypad 70 to execute the transaction software 62, which displays a PIN entry screen 80a (FIG. 4a) inviting the customer 16 to enter his/her PIN.

After entering the PIN, which the cell phone 60 encrypts and stores, the cell phone displays a request selection screen 80b (FIG. 4b).

In this example, the customer 16 selects a “withdraw cash” transaction request (labeled 84 in FIG. 4b). The transaction software 62 presents successive screens (not shown) to capture details of the desired transaction (transaction amount, whether a receipt is required, and the like).

As shown in FIG. 4b, one of the requests may be to obtain more information about a product, such as a loan or a mortgage.

Once the transaction details have all been entered by the customer 16, the transaction software 62 presents a lifetime screen 80c that presents expiry periods for the request. In this example, the customer 16 presses numeral three on the cell phone keypad 70 to select the option of the request expiring in one day (labeled 86 in FIG. 4c).

Once the request has been entered, the customer 16 then goes to the bank branch 10 prior to the expiry period. The customer then approaches one of the wireless transceiver stations 34 and establishes communication using the cell phone 60 to transmit the pre-staged request.

Once communication has been established, the customer 16 can transmit the pre-staged request block to the operator-assisted transaction system. This is achieved by the customer 16 selecting an option 88 automatically presented by the transaction software 62 on a request execution screen 80d (FIG. 4d).

On receipt of this pre-staged request, the transaction processor 36 parses the request block to create individual requests (where multiple requests are included in one request block) and to ascertain for each request if the teller 18a needs to take some action to fulfill the transaction. If the teller 18a needs to take some action to fulfill a request, then the operator-assisted transaction system conveys that pre-staged request to the teller station 28.

In this example, the teller 18a is notified because cash needs to be dispensed to the customer 16 once the transaction has been authorized. Notification involves the transaction processor 36 presenting the transaction details and customer identification information (for example, the customer's name) on the display 30.

The teller 18a receives notifications of all transactions that are pending and their status. Transactions that are pending include transactions entered by a customer 16 at a customer-operated terminal 22 and pre-staged transactions communicated via the wireless transceiver stations 24 and 34. The status of a transaction may be one of the following: authorized, declined, or pending authorization.

When the teller 18a is ready to serve the customer 16 who entered the pre-staged request described above, and that request has been authorized or declined by the authorization host 54, then the teller 18a calls that customer forward to the teller station 28 and the customer is identified. This may be performed by the customer providing documentary evidence (a bank card, a driving license, or the like) or by the customer using his/her cell phone 60 to establish communication with one of the wireless transceivers 34 located at the teller station 28.

Once the customer has been identified, the teller 18a dispenses to the customer 16 the cash requested in the pre-staged request, and the transaction details are removed from the display 30.

The above example relates to a single request; however, multiple requests may be prepared for separate execution, or the multiple requests may be coupled together to form one request block. On receipt of such a request block, the transaction processor 36 parses the block and routes each request appropriately. For example, if one of the pre-staged requests is a funds transfer request then the transaction processor 36 will route the request to the authorization host 54 to authorize the request and to transfer the funds if authorized. The teller 18a may be notified that this request has been executed, but the teller 18a is not required to fulfill the request.

If one of the requests is a cash withdrawal request that exceeds an amount set by the bank, then the transaction processor 36 may notify a supervisor (such as supervisor 18c in the back office 50) so that the supervisor 18c can decide whether the amount is to be dispensed. This notification may be by a message sent to a computer used by the supervisor 18c, or to a portable terminal carried by the supervisor 18c.

If one of the requests relates to a financial product, such as a mortgage or a loan, then the transaction processor 36 may route this request to a member of staff 18b who is a product specialist. The product specialist 18b may then meet with the customer 16c in private meeting area 40 (as illustrated in FIG. 1), or the transaction processor 36 may automatically schedule a meeting between the product specialist 18b and the customer 16c. The transaction processor 36 may update the schedule of the product specialist and communicate a meeting request to the customer 16c so that the cell phone 60 can process the meeting request and update the customer's schedule, as stored on the cell phone 60.

It will be appreciated that the above embodiment has the advantage that transactions may be generated in a secure environment prior to the time when the transaction will be executed. Another advantage of the above embodiment is that it enables the bank to provide inexpensive terminals at which a customer can communicate a transaction to the operator-assisted transaction system.

Various modifications may be made to the above described embodiment within the scope of the present invention. For example, the operator-assisted transaction system may be implemented in a non-bank environment, for example, a restaurant, a hotel, an airport, a car rental facility, or the like.

The transaction software 62 may allow for logical decisions to be included in the pre-staged request. For example, a balance request may be entered and if there is more than a first amount of money in the account (such as fifty pounds sterling) then a withdrawal of a second amount (such as thirty pounds) may be made; if there is not more than the first amount but there is more than a third amount (such as twenty pounds) then a withdrawal of a fourth amount (such as ten pounds) may be made; otherwise no withdrawal may be made. This allows the transaction flow to be dependent on certain conditions, such as the current state of the customer's account. Other possible transactions include transfer of funds based on the amount of funds in a certain account.

In other embodiments, the PIN may be permanently stored (in encrypted form) in the cell phone's memory so that each time a PIN is entered by a customer the entered PIN is compared with the decrypted PIN stored in memory, and if the two PINs are not identical then the customer may not be allowed to enter any transactions. The cell phone 60 may only permit a customer a predetermined number of successive failed PIN entries before deleting the stored PIN.

In other embodiments, an alarm function in the cell phone 60 may be provided to alert a customer to an unexecuted transaction nearing the end of its lifetime.

In other embodiments, the transaction software 62 may require a password to be entered prior to execution of any completed transaction and/or prior to entering any transactions.

In other embodiments, the cell phone 60 may transmit information about the language used (English, French, German, Spanish, or such like) to the operator-assisted transaction system.

In other embodiments, the portable terminal may not be a cell phone, it may be any convenient portable device.

In other embodiments, the portable terminal 60 may add a unique identification to each completed transaction. The identification may be a number, where the portable terminal 60 increments the number after assigning it to a transaction. This unique identification may be examined by the operator-assisted transaction system to ensure that the same identification has not been used before for that account. This would provide an additional security measure.

In other embodiments, a customer may register trusted third parties so that the third parties can be given the cell phone for preparing transactions. The third parties may be assigned access rights or may be assigned maximum values (such as thirty pounds sterling) for the transactions that they can prepare.

In other embodiments the function of the transaction processor may be distributed throughout the operator-assisted transaction system. For example, each wireless transceiver 24 and/or 34 may include some transaction processing and routing functions so that a wireless transceiver can route a transaction appropriately (for example, to the authorization host).

In other embodiments the portable terminal may include an integral biometrics unit, such as a fingerprint detector, and may store the registered customer's biometrics template in a tamper-resistant secure area within the portable terminal. This ensures that only the registered customer can execute a transaction, and only when the customer's finger is engaged with the fingerprint detector (that is, only when the registered customer is holding the portable terminal). The registered customer may register trusted third parties so that they can execute transactions while holding the portable terminal.

What is claimed is:

1. An operator-assisted transaction system for communicating with a portable terminal presented by a customer, the system comprising:
a wireless transceiver;
a transaction processor coupled to the wireless transceiver for (i) establishing communications with the portable terminal, (ii) receiving a pre-staged request block including a pre-staged transaction from the portable terminal, and (iii) parsing the request block to ascertain a customer identification and transaction details; and
an operator display coupled to the transaction processor for presenting the customer identification and transaction details to an operator to allow the operator to fulfill the pre-staged transaction.

2. A system according to claim 1, wherein the request block may comprise a plurality of individual transactions.

3. A system according to claim 1, wherein the request block includes product request information.

4. A system according to claim 1, wherein the transaction processor is coupled to a plurality of transaction fulfillment channels.

5. A system according to claim 4, wherein the wireless transceiver automatically routes parsed transaction details to different transaction fulfillment channels, depending on the transaction requested.

6. A system according to claim 5, wherein the wireless transceiver also provides an operator terminal with details of any transactions routed to other channels.

7. A system according to claim 1, wherein the wireless transceiver implements near field communications.

8. A system according to claim 1, wherein the operator-assisted transaction system includes an encryption/decryption facility to encrypt any messages transmitted to prevent fraud by third parties.

9. A method of executing a pre-staged transaction received from a portable terminal presented by a customer, the method comprising:
establishing communications with the portable terminal;
receiving a pre-staged transaction from the portable terminal;
parsing the transaction to ascertain a customer identification and transaction details; and
presenting the customer identification and transaction details to an operator to allow the operator to fulfill the pre-staged transaction.

10. A method according to claim 9, wherein the method comprises the further step of parsing transaction details to different transaction fulfillment channels, depending on the type of transaction requested.
